(19) United States
(12) Patent Application Publication
(10) Pub. No.: US 2025/0336172 A1
(43) Pub. Date: Oct. 30, 2025

(54) WELDING POSITION RECOGNITION APPARATUS FOR A BATTERY ASSEMBLY AND METHOD USING THE SAME

(71) Applicant: SK On Co., Ltd., Seoul (KR)

(72) Inventors: Hyeong Won KIM, Daejeon (KR); Jae Hun KIM, Daejeon (KR); Tae Wan KIM, Daejeon (KR); Ki Dong LEE, Daejeon (KR); Yoong Hee LEE, Daejeon (KR); Hyeon Jeong YOU, Daejeon (KR)

(21) Appl. No.: 19/189,158

(22) Filed: Apr. 24, 2025

(30) Foreign Application Priority Data
Apr. 26, 2024 (KR) 10-2024-0056288

(51) Int. Cl. G06V 10/147; G06V 10/145; G06V 10/25; H01M 10/04; H04N 23/58

(52) U.S. Cl. CPC G06V 10/147; G06V 10/145; G06V 10/25; H04N 23/58; H01M 10/0404

(57) ABSTRACT

The present disclosure relates to a welding position recognition apparatus for a battery assembly and a method using the same. The welding position recognition apparatus for the battery assembly according to embodiments of the present disclosure comprises a photographing unit spaced apart from the battery assembly to photograph a surface of the battery assembly including an area to be welded, a moving unit connected to the photographing unit and horizontally moving in parallel with the surface of the battery assembly, and a control unit controlling the photographing unit and the moving unit, wherein the control unit performs: first photographing of a portion of the surface of the battery assembly by the photographing unit to select a reference point, and second photographing of the surface of the battery assembly spaced apart from the reference point by a correction distance by the photographing unit.

### CROSS-REFERENCE TO RELATED PATENT APPLICATION

The present application claims priority under 35 U.S.C. § 119(a) to Korean patent application number 10-2024-0056288 filed on Apr. 26, 2024, in the Korean Intellectual Property Office, the entire disclosure of which is incorporated by reference herein.

### BACKGROUND OF THE INVENTION

### 1. Field

The present disclosure relates to a welding position recognition apparatus for a battery assembly and a method using the same, and more particularly, to a welding position recognition apparatus for a battery assembly for improving the manufacturing efficiency of the battery assembly and a method using the same.

### 2. Description of the Related Art

Secondary batteries may be classified into cylinder type, prismatic type, and pouched type batteries depending on their shape. However, the secondary batteries have a common feature that an electrode is inserted into the shape.

The electrode inserted into the inside of the shape includes electrode tabs for a cathode and an anode, and the electrode tabs may be in contact with and welded to each other to be electrically connected to an electrode lead in the form of a plate.

In addition, the electrode leads may be in contact with and welded to each other so as to be electrically connected to a bus bar. When a plurality of secondary batteries are connected, electrode leads of the respective secondary batteries may be in contact with and welded to each other. The shape in which the electrode is inserted is welded to a cap to cover an upper or lower surface, and welding is widely used to join each member during assembly processes of the secondary batteries.

However, a welding part (an area to be welded) which requires welding is difficult to recognize due to numerous noise factors such as scratches and foreign substances, which may reduce facility utilization and welding quality and increase the risk of welding defects and fires.

### SUMMARY OF THE INVENTION

An object of the present disclosure is to improve the manufacturing efficiency of a battery assembly.

Another object of the present disclosure is to improve the welding position recognition of the battery assembly.

Another object of the present disclosure is to reduce the photographing of a noise factor.

Another object of the present disclosure is to improve welding quality and prevent a deterioration in welding quality by increasing a recognition rate of an area to be welded.

The present disclosure can be widely applied in the field of electric vehicles, battery charging stations, and green technology, such solar power generation, and wind power generation using batteries. In addition, the present disclosure can be used in eco-friendly electric vehicles, hybrid vehicles, etc. to prevent climate change by suppressing air pollution and greenhouse gas emissions.

A welding position recognition apparatus for a battery assembly according to embodiments of the present disclosure comprises a photographing unit spaced apart from the battery assembly to photograph a surface of the battery assembly including an area to be welded, a moving unit connected to the photographing unit and horizontally moving in parallel with the surface of the battery assembly, and a control unit controlling the photographing unit and the moving unit, wherein the control unit performs: first photographing of a portion of the surface of the battery assembly by the photographing unit to select a reference point, and second photographing of the surface of the battery assembly spaced apart from the reference point by a correction distance by the photographing unit.

In one embodiment, the area to be welded may include an area where a first member and a second member arranged next to the first member are welded together, and the control unit may control the photographing unit so that the photographing unit photographs a portion of the first member during the first photographing.

In one embodiment, the control unit may control the photographing unit so that the photographing unit photographs a portion of the first member and the second member during the second photographing.

In one embodiment, the control unit may form a first recognition area in a first image obtained by the first photographing and a second recognition area in a second image obtained by the second photographing, and may set the first recognition area and the second recognition area to different sizes.

In one embodiment, the control unit may set a size of the second recognition area to be smaller than a size of the first recognition area.

In one embodiment, the control unit may form a portion of an outer region of the area to be welded in the first image as the first recognition area.

In one embodiment, the control unit may determine the area to be welded in the second recognition area formed in the second image.

In one embodiment, the welding position recognition apparatus may further comprise a lighting unit emitting light toward the surface of the battery assembly, and the photographing unit includes: a recognition sensor recognizing reflected light of irradiated light reflected on the surface of the battery assembly, a lens disposed between the recognition sensor and the surface of the battery assembly, and a mirror transmitting the reflected light incident on the photographing unit through the lens to the recognition sensor.

In one embodiment, a position of the mirror in the photographing unit may be adjusted by the control unit to change a photographing coordinate of the photographing unit.

In one embodiment, the control unit may change the photographing coordinate of the photographing unit by adjusting the lens or the mirror according to the correction distance while the photographing unit is in a fixed state when the correction distance is less than or equal to a predetermined value, and may move the photographing unit by the correction distance by the moving unit when the correction distance is greater than the predetermined value.

In one embodiment, the control unit may horizontally move the photographing unit by the correction distance by the moving unit when the correction distance is greater than a predetermined value.

In one embodiment, the control unit may change the photographing coordinate of the photographing unit by adjusting the lens or the mirror according to the correction distance when the photographing unit is in a fixed state.

In one embodiment, the correction distance may be changed based on a tolerance of a member used in manufacturing the battery assembly.

A method of recognizing a welding position for a battery assembly using a welding position recognition apparatus for the battery assembly according to embodiments of the present disclosure comprises performing first photographing of a portion of a first member on the surface of the battery assembly by a photographing unit to select a reference point, calculating a correction distance, selectively performing movement of the photographing unit by a moving unit or adjustment of a lens and a mirror by comparing the correction distance with a predetermined value, and performing second photographing of a portion of a second member in the surface of the battery assembly. In one embodiment, the welding position recognition apparatus may comprise a photographing unit spaced apart from a surface of the battery assembly including an area to be welded, photographing the surface of the battery assembly, and including a recognition sensor, the lens, and the mirror; the moving unit connected to the photographing unit and moving horizontally in parallel with the surface of the battery assembly; and a lighting unit irradiating light toward the surface of the battery assembly.

In one embodiment, in the selectively performing, when the correction distance is greater than the predetermined value, the moving unit may horizontally move the photographing unit by the correction distance.

In one embodiment, in the selectively performing, when the correction distance is less than or equal to the predetermined value, a photographing coordinate of the photographing unit may be changed by adjusting the lens or the mirror while the photographing unit in a fixed state.

In one embodiment, in the selectively performing, a photographing coordinate of the photographing unit may be changed by adjusting the lens or the mirror according to the correction distance when the photographing unit is in a fixed state.

In one embodiment, the recognition method may further include, after the performing of the second photographing, determining the area to be welded in a second image obtained by the second photographing, and performing welding.

### BRIEF DESCRIPTION OF THE DRAWINGS

FIG. 1 is a conceptual diagram of a welding position recognition apparatus for a battery assembly according to an embodiment of the present disclosure.

FIG. 2 is a perspective view of a photographing unit which photographs a surface of a battery assembly in a welding position recognition apparatus for a battery assembly according to an embodiment of the present disclosure.

FIG. 3 is a conceptual diagram of first photographing of a welding position recognition apparatus for a battery assembly according to an embodiment of the present disclosure.

FIG. 4 is a conceptual diagram of second photographing of a welding position recognition apparatus for a battery assembly according to an embodiment of the present disclosure.

FIG. 5 is a flowchart illustrating a welding position recognition method according to an embodiment of the present disclosure.

FIG. 6 is a flowchart illustrating a welding position recognition method according to another embodiment of the present disclosure.

FIG. 7 is a flowchart illustrating a welding position recognition method according to another embodiment.

### DETAILED DESCRIPTION

Hereinafter, the present disclosure will be described in detail with reference to the attached drawings. This is merely illustrative, and the present disclosure is not limited to the specific embodiments described in an illustrative manner.

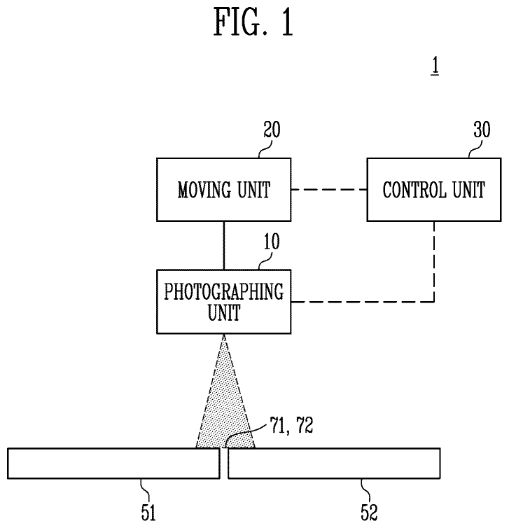

FIG. 1 is a conceptual diagram of a welding position recognition apparatus for a battery assembly according to an embodiment of the present disclosure.

A battery assembly according to an embodiment of the present disclosure may include a battery module or a battery pack in which one or more battery cells are grouped in order to protect the battery cells from external shock, heat, vibration, etc. and achieve high output and high capacity characteristics.

In addition, the battery cells include secondary batteries which may be repeatedly used by charging and discharging electric energy. Each of the battery cells may include a pouched secondary battery, a prismatic secondary battery, or a cylindrical secondary battery, depending on the shape thereof.

Referring to FIG. 1, a welding position recognition apparatus 1 for a battery assembly is located on upper surfaces of a first member 51 and a second member 52 corresponding to one surface of the battery assembly, and may determine an area to be welded 90 in which welding is required in the battery assembly.

The welding position recognition apparatus 1 for the battery assembly may include a photographing unit 10 which photographs one surface of the battery assembly, a moving unit 20 which moves the photographing unit 10 to adjust the position, a control unit 30 which controls the photographing unit 10 and the moving unit 20, and a lighting unit.

The photographing unit 10 may be spaced apart from one surface of the battery assembly including the area to be welded 90 to take a photograph of one surface of the battery assembly. The photographing unit 10 photographs one surface of the battery assembly with a fixed position and may determine the area to be welded 90 by perform photographing twice (i.e., first photographing and second photographing).

The photographing unit 10 may perform photographing at least twice to determine the area to be welded 90, and the photographing unit 10 may be moved between the two performs.

The photographing unit 10 may be located on the upper surfaces of the first member 51 and the second member 52 in order to take a photograph of the area to be welded 90 for welding the first member 51 and the second member 52 arranged next to the first member 51.

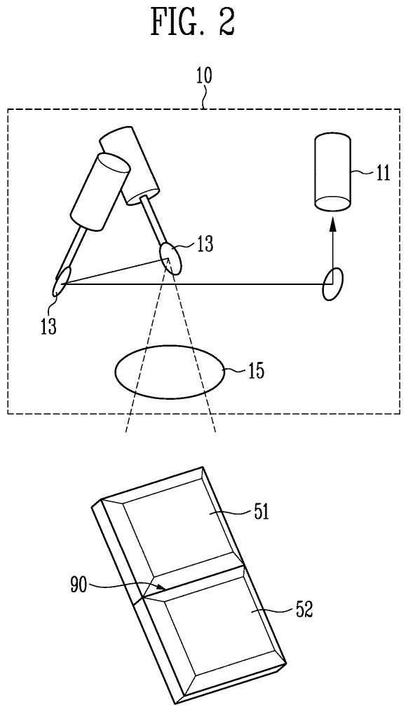

The photographing unit 10 may photograph reflected light reflected from one surface of the battery assembly, and the reflected light may be formed by the lighting unit. More specifically, the photographing unit 10 includes a recognition sensor 11, a lens 15, and a mirror 13, which will be described below with reference to FIG. 2.

The moving unit 20 may move the photographing unit 10 in parallel with one surface of the battery assembly including the area to be welded 90. The moving unit 20 is connected to the photographing unit 10 and may move horizontally in parallel with one surface of the battery assembly.

The moving unit 20 may adjust the position by moving the photographing unit 10 horizontally on a plane formed by the X-axis and the Y-axis while maintaining the height of the photographing unit 10.

In addition, the moving unit 20 may move the photographing unit 10 in the Z-axis which is a direction closer to or away from one surface of the battery assembly.

The moving unit 20 may include a sub-motor (not shown) which enables parallel movement to the X-axis, the Y-axis, or the Z-axis in order to adjust the position and focus of the photographing unit 10 before and after photographing, and a rail (not shown) which is a path along which the photographing unit 10 moves.

The X-axis and the Y-axis are horizontal to one surface of the battery assembly, and the Z-axis is vertical to one surface of the battery assembly. The horizontal movement means a movement in the X-axis and the Y-axis.

The moving unit 20 may move the photographing unit 10 horizontally so as to face between the first member 51 and the second member 52 of the battery assembly. Referring to FIG. 1, the photographing unit 10 is disposed so as to face the area to be welded 90 for coupling the first member 51 and the second member 52.

The moving unit 20 may adjust the height of the photographing unit 10 with respect to the battery assembly by moving the photographing unit 10 in the Z-axis to focus the photographing unit 10. When the height of the photographing unit 10 is fixed before the first photographing, the first photographing and the second photographing may be performed at the same height.

The first photographing and the second photographing of the photographing unit 10 are performed at the same height, and the photographing unit 10 may be horizontally moved by the moving unit 20 between the first photographing and the second photographing according to a correction distance α which is calculated by the control unit 30.

The control unit 30 may control the photographing unit 10 and the moving unit 20. The control unit 30 may control the photographing of the photographing unit 10 and the movements of the recognition sensor 11, the lens 15, and the mirror 13 disposed in the photographing unit 10. The control unit 30 may control the photographing unit 10 to perform first photographing

in which a reference point is selected by photographing a part of one surface of the battery assembly by the photographing unit 10, and a second photographing in which a surface of the battery assembly spaced apart from the reference point by the correction distance α is photographed by the photographing unit 10.

The control unit 30 may adjust a Region of Interest (ROI) from an image captured by the photographing unit 10. The control unit 30 may adjust the size of the recognition area corresponding to the ROI.

The control unit 30 may set a first recognition area 71 in the first image obtained by the first photographing and a second recognition area 72 in the second image obtained by the second photographing to different sizes.

The size of the first image obtained by the first photographing and the size of the second image obtained by the second photographing may be the same. However, the sizes of the first recognition area 71 and the second recognition area 72 may be formed differently.

In addition, the control unit 30 may control the moving unit 20 to move the photographing unit 10 or move and adjust the internal configurations of the photographing unit 10.

When the photographing unit 10 moves, the photographing unit 10 may move on the rail by the moving unit 20, and the recognition sensor 11, the lens 15, and the mirror 13 in the photographing unit 10 are fixed. The photographing unit 10 may move in a state in which the focus is fixed, and an image to be photographed may vary by the movement of the photographing unit 10. The photographing unit 10 may be moved horizontally by the moving unit 20, so that photographing in a relatively wide range is possible.

When the internal configuration of the photographing unit 10 moves, the lens 15 and the mirror 13 in the photographing unit 10 may move while the photographing unit 10 is fixed. For example, at least one of the lens 15 and the mirror 13 may be axially rotated and moved in the photographing unit 10.

While the recognition sensor 11 is fixed, the lens 15 and the mirror 13 which transmit reflected light reflected from one surface of the battery assembly to the recognition sensor 11 may move. By adjusting the position of at least one of the lens 15 and the mirror 13, it is possible to change the photographing area within a relatively short time. The lens 15 or the mirrors 13 may be adjusted faster than the horizontal movement of the photographing unit 10 by the moving unit 20.

The lens 15 may be moved up and down and the angle of the lens 15 may be changed. In addition, the angle of the mirror 13 may be changed and the mirror 13 may be moved. The lens 15 and the mirror 13 may move independently of each other.

For example, when the positions of the recognition sensor 11 and the lens 15 are fixed, the mirror 13 may be moved to change the movement path of the reflected light passing through the lens 15 or the photographing coordinates of the photographing unit 10 and transmit the light to the recognition sensor 11.

As the movement path of the reflected light or the photographing coordinates of the photographing unit 10 change, an image recognized by the recognition sensor 11 may change.

At least two mirrors 13 may be formed, and the angles of the mirrors 13 may be changed or the mirrors 13 may be moved by a motor to change the positions.

The control unit 30 may calculate the correction distance α or may receive the correction distance α calculated from the outside. The correction distance α is information for correcting the photographing unit 10 after the first photographing is finished and before the second photographing starts, and may be calculated in real time.

The correction distance α may be changed based on a tolerance of a member used in manufacturing the battery assembly. The correction distance α is calculated through data of tolerances in the member or process, and may vary depending on the member and the process in which welding is performed. For example, the correction distance α may be calculated by the control unit 30 in consideration of the tolerances described in the drawing of the member. Alternatively, the correction distance α may be calculated by the control unit 30 by measuring the tolerance of the reference through various facilities, which measure the distance, such as a displacement sensor.

When the data for the correction distance α is accumulated, the correction distance α may be set to a constant value.

By comparing the correction distance α with a predetermined value, the photographing unit 10 or the internal configuration of the photographing unit 10 may be selectively moved by the moving unit 20.

The lighting unit (not shown) may irradiate light toward one surface of the battery assembly. The lighting unit may be disposed adjacent to the lens 15 so as to irradiate light to the imaging area of the lens 15.

More specifically, the lighting unit may irradiate light to the area to be welded 90 where the first member 51 and the second member 52 face each other. The lighting unit may be formed adjacent to the photographing unit 10 in the welding position recognition apparatus 1 of the battery assembly, or may be formed integrally with the photographing unit 10.

The lighting unit may be disposed at an upper end above the lens 15 of the photographing unit 10 so as not to directly irradiate the lens 15 with light.

FIG. 2 is a perspective view of the photographing unit 10 which photographs one surface of the battery assembly in the welding position recognition apparatus 1 for the battery assembly according to an embodiment of the present disclosure.

The photographing unit 10 is disposed to face one surface of the battery assembly, and may include the recognition sensor 11, the mirrors 13, and the lens 15.

The recognition sensor 11 may recognize reflected light from which the irradiated light is reflected on one surface of the battery assembly. The recognition sensor 11 acquires an image through reflected light coming from the lens 15, and the acquired image may be transmitted to the control unit 30.

The welding position recognition apparatus 1 for the battery assembly forms a recognition area from the image acquired by the recognition sensor 11 through the control unit 30 and analyzes the welding scheduled area 90, which may correspond to preliminary processes of a welding work.

The lens 15 may be disposed between the recognition sensor 11 and one side of the battery assembly. The lens 15 may be moved up and down or the angle thereof may be adjusted through the control unit 30.

The mirrors 13 may be movably provided and transmit reflected light incident on the photographing unit 10 through the lens 15 to the recognition sensor 11. The mirrors 13 may include at least two mirrors and may be moved or adjusted in angle by the control unit 30.

Referring to FIG. 2, the mirror 13 with a fixed position is arranged under the recognition sensor 11, and two mirrors 13 equipped with motors oppose the lens 15. The mirrors 13 equipped with the motors may receive a signal through the control unit 30 and move or adjust the angle.

The mirrors 13 may be adjusted independently of each other, and the movement path of the reflected light may be changed according to the movements of the mirrors 13. Thus, an image obtained by the recognition sensor 11 may be changed.

For example, when only the mirror 13 moves while the position of the lens 15 and one surface of the battery assembly are fixed, the angle at which the reflected light incident through the lens 15 meets the mirror 13 may be changed, and thus, the position of the image focused on the recognition sensor 11 may be changed. In a state where the position of the photographing unit 10 is fixed, another image may be acquired by the recognition sensor 11 through the movement of the mirror 13.

One surface of the battery assembly facing the photographing unit 10 may include the first member 51 and the second member 52 disposed next to the first member 51. The first member 51 and the second member 52 are disposed to face each other and may be in contact with each other.

FIG. 2 illustrates that the first member 51 and the second member 52 are arranged next to each other. However, the first member 51 and the second member 52 may be arranged to be stacked on top of each other vertically. The first member 51 and the second member 52 may be joined through welding, and may include an electrode tab-electrode lead, an electrode lead-busbar, an electrode lead-electrode lead, a shape-cap, and the like in the battery assembly.

The shapes of the first member 51 and the second member 52 are not limited, and the first member 51 and the second member 52 may correspond to members requiring welding in the assembly process of a battery assembly including electrodes.

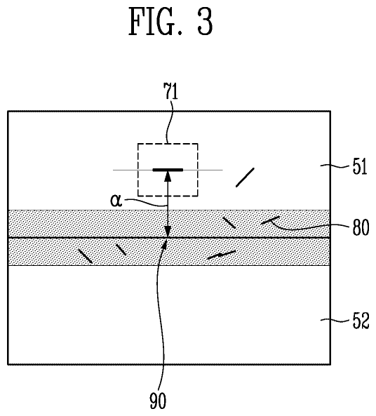

FIG. 3 is a conceptual diagram of first photographing of the welding position recognition apparatus 10 for the battery assembly according to an embodiment of the present disclosure.

The control unit 30 may control the photographing unit 10 so that the first photographing and the second photographing may be performed by the photographing unit 10. FIG. 3 is a diagram for explaining the first photographing. The control unit 30 may control the photographing unit 10 to perform the first photographing for selecting a reference point by photographing a part of one surface of the battery assembly by the photographing unit 10.

The control unit 30 may acquire an image of one of the first member 51 and the second member 52 in the first photographing. FIG. 3 shows that the control unit 30 controls the photographing unit 10 to perform the first photographing of a part of the first member 51 by the photographing unit 10.

The control unit 30 may obtain an image of the first member 51 or the second member 52 which deviates from an area in which the first member 51 and the second member 52 are adjacent in the first photographing. The first photographing is photographing for setting the reference point, and the second photographing may start after the photographing unit 10 is corrected based on the first photographing.

The control unit 30 may form the first recognition area 71 in a first image obtained by the first photographing. The first recognition area 71 may correspond to the ROI, and may be an area in which the control unit 30 performs recognition from the first image. Alternatively, the first image may correspond to the first recognition area 71 according to the magnification of the lens 15.

The first recognition area 71 may be an area in which the arrangement of scratches 80 or foreign substances is minimized on the first member 51 or the second member 52. The first recognition area 71 may be formed on the first member 51 and may be spaced apart from the second member 52.

The first recognition area 71 may correspond to a datum and be a reference point for performing a second photographing. The control unit 30 may control the photographing unit 10 so that the second photographing is performed after the correction is performed based on the first recognition area 71.

Referring to FIG. 3, the scratches 80 or the foreign substances may be naturally formed in the first member 51 and the second member 52. However, the scratches 80 or the foreign substances may not be present in the first recognition area 71.

In the first image, differences in color, saturation, brightness, or the like may appear due to a step in a part where the first member 51 and the second member 52 face each other or come into contact with each other. The control unit 30 may set the first recognition area 71 to avoid the above differences, the scratches 80, or the foreign objects in the first image.

The control unit 30 may expect the above difference, the scratches 80, the foreign matter, etc. as the area to be welded 90, and may form a part of the external area of the area to be welded 90 expected in the first image as the first recognition area 71.

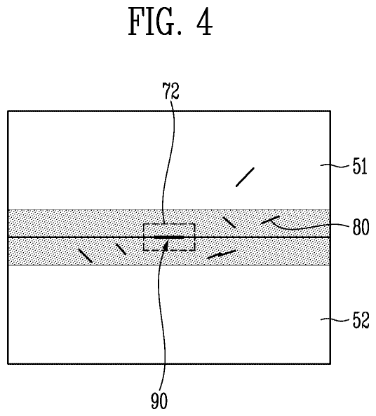

FIG. 4 is a conceptual diagram of a second photographing of the welding position recognition apparatus 1 for the battery assembly according to an embodiment of the present disclosure.

The control unit 30 may control the photographing unit 10 so that the second photographing is performed after the first photographing by the photographing unit 10. FIG. 4 is a diagram for explaining the second photographing. The control unit 30 may control the photographing unit 10 to perform the first photographing, calculate or receive the correction distance α, and compare the correction distance α with a predetermined value.

After the first photographing, the photographing unit 10 may be adjusted and the second photographing may be performed.

The control unit 30 may compare the correction distance α with the predetermined value to move the photographing unit 10 by the moving unit 20 or may adjust the mirror 13 or the lens 15 in the photographing unit 10.

When the correction distance α is less than or equal to the predetermined value, the control unit 30 changes the photographing coordinates of the photographing unit 10 in a fixed state by adjusting the mirrors 13 or the lens 15. On the other hand, when the correction distance a exceeds the predetermined value, the moving unit 20 may adjust the position of the photographing unit 10. The control unit 30 may control the moving unit 20 so that the moving unit 20 may move the photographing unit 10 by the correction distance α.

The control unit 30 may have an adjustment target which varies depending on the correction distance α.

When the correction distance α is less than or equal to the predetermined value, correction of the photographing unit 10 is not required so much, which may mean that the tolerance of the member used for manufacturing the battery assembly is small.

When the correction distance α is less than or equal to the predetermined value, it is more efficient to adjust the mirrors 13 or the lens 15 in the photographing unit 10 than to move the photographing unit 10 by the moving unit 20.

When the position of the photographing unit 10 is fixed, the focus may be quickly changed

by adjusting the lens 15 or the mirrors 13 in the photographing unit 10 through the motors. Particularly, the control unit 30 may change the photographing coordinate of the photographing unit 10 by adjusting the mirrors 13 or the lens 15 according to the correction distance α when the photographing unit 10 is in a fixed state. Since the lens 15 or the mirrors 13 are adjusted in a state where the positions of the lighting unit and the photographing unit 10 are fixed, the brightness and the angle of light of the first image and the second image may be the same as each other.

When the correction distance α is greater than the predetermined value, relatively much correction of the photographing unit 10 is required. Thus, the control unit 30 may move the photographing unit 10 by the moving unit 20.

When the control unit 30 moves the photographing unit 10 by the moving unit 20, the

photographing unit 10 is horizontally moved in a state where the focus is constant. Thus, there may be no need to refocus. When the photographing unit 10 is moved by the moving unit 20, the distance between the lighting unit and the photographing unit 10 is changed, and the brightness and the angle of light of the first image and the second image may be changed. As a result, further adjustment of brightness or the like may be required.

Alternatively, when the correction distance α is greater than the predetermined value, complex adjustment may be used such that the control unit 30 may be moved shorter than the correction distance α, and the lens 15 or the mirrors 13 in the photographing unit 10 may be adjusted by the motor.

The second photographing may be performed by the photographing unit 10 under the control of the control unit 30 after the first photographing and the adjustment of the photographing unit 10.

The control unit 30 may control the photographing unit 10 so that the second photographing may be performed by photographing one surface of the battery assembly spaced apart by the correction distance α from the reference point by the photographing unit 10. The control unit 30 may control the photographing unit 10 to perform the second photographing for photographing a part of the first member 51 and the second member 52 by the photographing unit 10.

FIG. 4 illustrates the second recognition area 72 in a second image obtained by the second photographing, and the second recognition area 72 may be formed at a different position from the first recognition area 71.

The control unit 30 may control the photographing unit 10 to take a photograph of a position at which the area to be welded 90 is expected in the second photographing to obtain the second image and form the second recognition area 72. The control unit 30 may set the first recognition area 71 and the second recognition area 72 to different sizes.

The sizes of the first recognition area 71 and the second recognition area 72 may be formed differently.

When the first recognition area 71 of FIG. 3 is compared against the second recognition area 72 of FIG. 4, the size of the first recognition area 72 is greater than the size of the second recognition area 62.

The size of the second recognition area 72 may be smaller than the size of the first recognition area 71. The control unit 30 may reduce the size of the second recognition area 72 so as to determine the area to be welded 90.

The control unit 30 may reduce the size of the area by setting a part of the second image obtained by the second photographing as the second recognition area 72. The control unit 30 may determine the area to be welded 90 from the second recognition area 72 with the reduced size.

Referring to FIG. 4, the first member 51 and the second member 52 are in contact with each other in the second recognition area 72, so that the area to be welded 90 requiring welding is formed. The scratches 80 or the foreign matters may be disposed around the area to be welded 90, and the control unit 30 may reduce the size of the second recognition area 72, so that the scratches 80 or the foreign material may not be included in the second recognition area 62.

The control unit 30 may reduce the recognition of scratches 80 or the foreign substances by reducing the size of the second recognition area 72.

The welding position recognition method according to an embodiment of the present disclosure may increase the recognition accuracy of the area to be welded 90 by performing the first photographing and the second photographing.

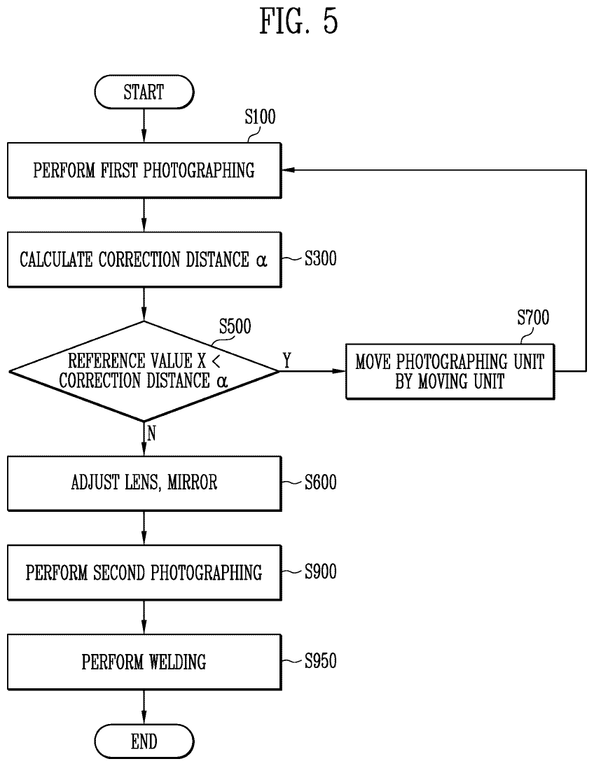

FIG. 5 is a flowchart illustrating a welding position recognition method according to an embodiment of the present disclosure.

The welding position recognition method may be performed using the above welding position recognition apparatus. The welding position recognition method may include taking first photographing at step S100, selectively performing, taking a second photographing at step S900, and welding at step S950. In the selectively performing may include calculating the correction distance α calculation process at step S300, comparing the correction distance α with a predetermined value (a reference value X) at step S500, moving the photographing unit 10 by the moving unit 20 at step S700, adjusting the lens 15 or the mirrors 13 at step S600,

In the first photographing at step S100, a reference point may be selected by photographing a part of the first member 51 on one surface of the battery assembly by the photographing unit 10. The first photographing may be performed by the photographing unit 10, and an image of one of the first member 51 and the second member 52 included in one surface of the battery assembly may be acquired.

The first photographing at step S100 may form the first recognition area 71 in the first image obtained by the first photographing. The first photographing is performed to set the reference point, and the correction of the photographing unit 10 may be performed with respect to the correction distance α based on the first photographing.

In the first photographing at step S100, a partial area may be set in the first image so that scratches 80, foreign substances, etc. may not be included in the first recognition area 71.

In the correction distance α calculation at step S300, the correction distance α is calculated through data of transmitted tolerances on the member or process, and may vary depending on the member and the process in which welding is performed. Alternatively, the correction distance α which is calculated from the outside may be received at step S300.

When the welding position recognition method is repeated, the correction distance α may be determined as a constant value through data accumulation at step S300.

At step S500 of comparing the correction distance α with the predetermined value (the reference value X), comparison may be made to find out whether the correction distance α is greater than the predetermined value X or not. By comparing the correction distance α with the predetermined value X, whether the photographing unit 10 is moved by the moving unit 20, or the lens 15 or the mirrors 13, which are internal components of the photographing unit 10, are adjusted may be selected.

When the correction distance α is greater than the predetermined value X, the photographing unit 10 may be moved by the moving unit 20 which horizontally moves the photographing unit 10 by the correction distance α at step S700. When the correction distance α is less than or equal to the predetermined value x, the lens 15 or the mirrors 13 may be adjusted at step S600.

When the correction distance α is less than or equal to the predetermined value X, the correction of the photographing unit 10 is not required so much, which may mean that the tolerance of the member used for manufacturing the battery assembly is small.

When the correction distance α is less than or equal to the predetermined value X, it is more efficient to adjust the lens 15 in the photographing unit 10 than to move the photographing unit 10 by the moving unit 20. When the correction distance α is less than or equal to the predetermined value X, a photographing coordinate of the photographing unit 10 may be changed by adjusting the lens 13 or the mirror 14 while the photographing unit in a fixed state. Particularly, the photographing coordinate of the photographing unit 10 may be changed by adjusting the lens 13 or the mirror 14 according to the correction distance α when the photographing unit 10 is in a fixed state.

Since the lens 15 is adjusted while the positions of the lighting unit and the photographing unit 10 are fixed, the first image obtained by the first photographing at step S100 and the second image obtained by the second photographing at step S900 may have the same brightness and the same angle of light.

When the correction distance α is greater than the predetermined value X, much correction of the photographing unit 10 is required, and the moving unit 20 may move the photographing unit 10.

When the moving unit 20 moves the photographing unit 10, the photographing unit 10 is horizontally moved in a state where the focus is constant. Thus, there is no need to refocus. When the photographing unit 10 is moved by the moving unit 20, the distance between the lighting unit and the photographing unit 10 is changed. Thus, additional adjustments such as brightness may be required at step S900.

At step S700 of moving the photographing unit 10 by the moving unit 20, the photographing unit 10 may be moved by the moving unit 20 and the moving unit 20 may move the photographing unit 10 disposed on the rail using a sub-motor. The moving unit 20 may adjust the position by moving the photographing unit 10 horizontally while maintaining the height of the photographing unit 10.

Step S700 of moving the photographing unit 10 by the moving unit 20 may be performed after step S300 of calculating the correction distance α. Step S700 may be performed when the correction distance α is greater than the predetermined value X as a result of comparing the correction distance α with the predetermined value X at step S500.

In FIG. 5, step S600 of adjusting the lens 15 or the mirrors 13 may be performed when the correction distance α is less than or equal to the predetermined value X at step S500 of comparing the predetermined value X.

At step S600, the lens 15 or the mirrors 13, which are the internal configuration of the photographing unit 10, may be adjusted while the position of the photographing unit 10 is fixed. The lens 15 may move up and down and the angle thereof may be changed, and the mirrors 13 may change the position and angle thereof, so that the photographing coordinates of the photographing unit 10 may be changed by adjusting the lens 15 or the mirrors 13.

The mirrors 13 may change the movement path of the reflected light incident through the lens 15. By adjusting the mirrors 13, the movement path of the reflected light in the photographing unit 10 is changed, so that an image obtained by the photographing unit 10 may be changed.

At least two mirrors 13 may be formed in the photographing unit 10, and the angles of the mirrors may be changed or moved by motors to change the positions. The plurality of mirrors 13 may be adjusted independently of each other, and the position of the focus in the photographing unit 10 may be changed according to the movements of the mirrors 13, so that the image obtained by the photographing unit 10 may be changed. The lens 15 or the mirrors 13 may be adjusted at step S600 to help the photographing

unit 10 to take a second image different from the first image in the second photographing at step S900.

In the welding position recognition method according to the present embodiment, feedback may be applied to return to the first photographing at step S100 after step S700 of moving the photographing unit 10 by the moving unit 20.

After step S700 of moving the photographing unit 10 by the moving unit 20, the first photographing at step S100 and the correction distance α calculation at step S300 proceed again, so that the correction distance α may be calculated several times.

When the recalculated correction distance α is greater than the predetermined value X at step S500 of comparing the correction distance α with the predetermined value X, step S700 of moving the photographing unit 10 by the moving unit 20 proceeds again. When the correction distance α is less than or equal to the predetermined value x, step S600 of adjusting the lens 15 or the mirrors 13 may proceed.

After the adjustment of the lens 15 or the mirrors 13 at step S600, the second photographing at step S900 may be performed.

In the second photographing at step S900, a part of the first member 51 and the second member 52 on one surface of the battery assembly may be photographed by the photographing unit 10. The second photographing at step S900 may form the second recognition area 72 in the second image obtained by the second photographing.

In the second photographing at step S900, the size of the second recognition area 72 may be smaller than the size of the first recognition area 71 formed in the first photographing at step S100. In the second photographing at step S900, a part of the second image obtained by the second photographing may be set as the second recognition area 72 to thereby reduce the size of the area.

In the second photographing at step S900, the size of the second recognition area 72 may be reduced so as not to include the scratches 80 or foreign substances in the second recognition area 62. In the second photographing at step S900, the size of the second recognition area 72 may be reduced to minimize the scratches 80 or foreign substances recognized in the second recognition area 62.

The welding position recognition method may further include, after the second photographing at step S900, determining the area to be welded 90 in the second image obtained by the second photographing.

During determination of the area to be welded 90, the area to be welded 90, which is a part where welding is required to be performed may be determined within the second recognition area 72 formed in the second photographing at step S900.

During determination of the area to be welded 90, a contact area between the first member 51 and the second member 52 may be determined based on differences in color, saturation, brightness, or the like between pixels included in the second recognition area 72.

During determination of the area to be welded 90, when the first member 51 and the second member 52 are arranged next to each other, an empty space between the first member 51 and the second member 52 may be identified, and when the first member 51 overlaps with the second member 52, a step difference may be identified to determine the area to be welded 90. Occasionally, even when the scratches 80 or foreign matters are included in the second

recognition area 72, the size of the scratches 80 or the size of the foreign matter may be compared by estimating the size of a size required for the area to be welded 90 according to the sizes of the first member 51 and the second member 52 to thereby determine the area to be welded 90.

When the area to be welded 90 is not determined even after the second photographing at S900 is performed, the photographing unit 10 may perform additional photographing by reducing the size of the recognition area.

After the second photographing at step S900, welding is performed may be performed at S950. In the welding at step S950, welding may be performed on the area to be welded 90 which is determined through the preceding processes.

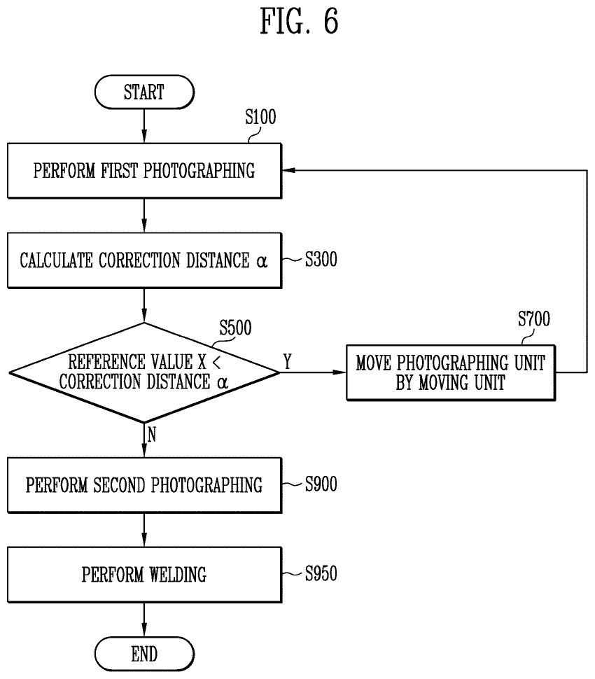

FIG. 6 is a flowchart illustrating a welding position recognition method according to another embodiment of the present disclosure. A description will be made by comparing the welding position recognition method of FIG. 6 with the welding position recognition method according to an embodiment of the present disclosure as shown in FIG. 5.

Referring to FIG. 6, performing first photographing at step S100, calculating the correction distance α calculation at step S300, comparing the correction distance α with the predetermined value X at step S500, moving the photographing unit 10 by the moving unit 20 at step S700, second photographing at step S900, and welding at step S950 may be included.

As compared with FIG. 5, adjusting the lens 15 or the mirrors 13 at step S600 may be omitted. Similarly, when the correction distance α is greater than the predetermined value X at S500 of comparing the correction distance α with the predetermined value X, step S700 of moving the photographing unit 10 by the moving unit 20 is performed. On the other hand, when the correction distance α is less than the predetermined value x, the second photographing at step S900 may be performed without correction.

When the correction distance α is less than the predetermined value X, the second photographing may be performed without adjusting the lens 15 or the mirrors 13. Even when the correction distance α is calculated, the second photographing may proceed without further correction if the calculated correction distance α corresponds to a small value.

Performing the first photographing at step S100, calculating the correction distance α at step S300, comparing the correction distance α with the predetermined value (the reference value X) at step S500, moving the photographing unit 10 by the moving unit 20 at step S700, adjusting the lens 15 or the mirrors 13 at step S600, the second photographing at step S900, and the welding at step S950 may be included.

Step S700 of moving the photographing unit 10 by the moving unit 20 may be performed when the correction distance α is greater than the predetermined value X at S500 of comparing the correction distance α with the predetermined value X.

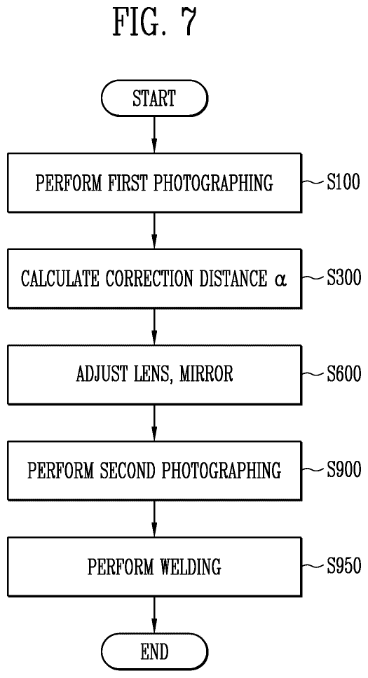

FIG. 7 is a flowchart illustrating a welding position recognition method according to another embodiment. A description is made below by comparing the welding position recognition method of FIG. 7 with the welding position recognition method according to an embodiment of FIG. 5.

Referring to FIG. 7, first photographing at step S100, calculating the correction distance a at step S300, adjusting the lens 15 or the mirrors 13 at step S600, second photographing at step S900, and welding at step S950 may be included.

As compared with the method of FIG. 5, comparing the correction distance α with the predetermined value X at step S500 and moving the photographing unit 10 by the moving unit 20 at step S700 may be omitted.

After the first photographing, the correction distance α is calculated at step S300. However, the lens 15 or the mirrors 13 may be adjusted at step S600 immediately without comparing the correction distance α with the predetermined value X.

Referring to the embodiments of FIGS. 5 to 7, the overall flows of the steps are similar to each other, but step S500 of comparing the correction distance α with the predetermined value X, step S600 of adjusting the mirrors 13, and step S700 of moving the photographing unit 10 by the moving unit 20 may be selectively applied. In the welding position recognition method according to the present disclosure, moving the photographing unit 10 by the moving unit 20, or adjusting the lens 15 and the mirrors 13 may be selectively applied. According to an embodiment, the photographing unit 10 may be moved by the moving unit 20 while the lens 15 and the mirror 13 are not adjusted, or the lens 15 or the mirrors 13 may be adjusted while the photographing unit 10 is fixed.

Alternatively, double adjustment may be applied such that the lens 15 or the mirrors 13 may be adjusted after the photographing unit 10 is moved by the moving unit 20.

According to an embodiment of the present disclosure, the manufacturing efficiency of a battery assembly may be improved.

According to another embodiment of the present disclosure, the welding position recognition of a battery assembly may be improved.

According to another embodiment of the present disclosure, the photographing of a noise factor may be reduced.

According to another embodiment of the present disclosure, welding quality may be improved and deterioration in welding quality may be prevented by increasing a recognition rate of an area to be welded.

In addition, welding may be performed reliably regardless of a length of a lead tab portion.

The present disclosure may be modified and implemented in various forms, and its scope is not limited to the above-described embodiments. The content described above is merely an example of applying the principles of the present disclosure, and other features may be further included without departing from the scope of embodiments according to the present disclosure.

What is claimed is:

1. A welding position recognition apparatus for a battery assembly, the welding position recognition apparatus comprising:
a photographing unit spaced apart from the battery assembly to photograph a surface of the battery assembly including an area to be welded;
a moving unit connected to the photographing unit and horizontally moving in parallel with the surface of the battery assembly; and
a control unit controlling the photographing unit and the moving unit,
wherein the control unit performs:
first photographing of a portion of the surface of the battery assembly by the photographing unit to select a reference point; and
second photographing of the surface of the battery assembly spaced apart from the reference point by a correction distance by the photographing unit.

2. The welding position recognition apparatus of claim 1, wherein the area to be welded includes an area where a first member and a second member arranged next to the first member are welded together, and
wherein the control unit controls the photographing unit so that the photographing unit photographs a portion of the first member during the first photographing.

3. The welding position recognition apparatus of claim 2, wherein the control unit controls the photographing unit so that the photographing unit photographs a portion of the first member and the second member during the second photographing.

4. The welding position recognition apparatus of claim 3, wherein the control unit: forms a first recognition area in a first image obtained by the first photographing and a second recognition area in a second image obtained by the second photographing, and
sets the first recognition area and the second recognition area to different sizes.

5. The welding position recognition apparatus of claim 4, wherein the control unit sets a size of the second recognition area to be smaller than a size of the first recognition area.

6. The welding position recognition apparatus of claim 4, wherein the control unit forms a portion of an outer region of the area to be welded in the first image as the first recognition area.

7. The welding position recognition apparatus of claim 6, wherein the control unit determines the area to be welded in the second recognition area formed in the second image.

8. The welding position recognition apparatus of claim 1, further comprising a lighting unit emitting light toward the surface of the battery assembly,
wherein the photographing unit includes:
a recognition sensor recognizing reflected light of irradiated light reflected on the surface of the battery assembly;
a lens disposed between the recognition sensor and the surface of the battery assembly; and
a mirror transmitting the reflected light incident on the photographing unit through the lens to the recognition sensor.

9. The welding position recognition apparatus of claim 8, wherein a position of the mirror in the photographing unit is adjusted by the control unit to change a photographing coordinate of the photographing unit.

10. The welding position recognition apparatus of claim 9, wherein the control unit:
changes the photographing coordinate of the photographing unit by adjusting the lens or the mirror according to the correction distance while the photographing unit is in a fixed state when the correction distance is less than or equal to a predetermined value, and
moves the photographing unit by the correction distance by the moving unit when the correction distance is greater than the predetermined value.

11. The welding position recognition apparatus of claim 9, wherein the control unit horizontally moves the photographing unit by the correction distance by the moving unit when the correction distance is greater than a predetermined value.

12. The welding position recognition apparatus of claim 9, wherein the control unit changes the photographing coordinate of the photographing unit by adjusting the lens or the mirror according to the correction distance when the photographing unit is in a fixed state.

13. The welding position recognition apparatus of claim 1, wherein the correction distance is changed based on a tolerance of a member used in manufacturing the battery assembly.

14. A method of recognizing a welding position for a battery assembly using a welding position recognition apparatus for the battery assembly, the method comprising:
performing first photographing of a portion of a first member on the surface of the battery assembly by a photographing unit to select a reference point;
calculating a correction distance;
selectively performing movement of the photographing unit by a moving unit or adjustment of a lens and a mirror by comparing the correction distance with a predetermined value; and
performing second photographing of a portion of a second member in the surface of the battery assembly,
wherein the welding position recognition apparatus comprises
a photographing unit spaced apart from a surface of the battery assembly including an area to be welded, photographing the surface of the battery assembly, and including a recognition sensor, the lens, and the mirror;
the moving unit connected to the photographing unit and moving horizontally in parallel with the surface of the battery assembly; and
a lighting unit irradiating light toward the surface of the battery assembly.

15. The method of claim 14, wherein in the selectively performing, when the correction distance is greater than the predetermined value, the moving unit horizontally moves the photographing unit by the correction distance.

16. The method of claim 15, wherein in the selectively performing, when the correction distance is less than or equal to the predetermined value, a photographing coordinate of the photographing unit is changed by adjusting the lens or the mirror while the photographing unit in a fixed state.

17. The method of claim 14, wherein in the selectively performing, a photographing coordinate of the photographing unit is changed by adjusting the lens or the mirror according to the correction distance when the photographing unit is in a fixed state.

18. The method of claim 14, further comprising, after the performing of the second photographing, determining the area to be welded in a second image obtained by the second photographing, and performing welding.
